(19) United States
(12) Patent Application Publication
(10) Pub. No.: US 2011/0145419 A1
(43) Pub. Date: Jun. 16, 2011

(54) INTER-DEVICE MOBILITY SESSION RELEASE

(75) Inventors: Kamel M. Shaheen, King of Prussia, PA (US); Milan Patel, Middlesex (GB); Xavier De Foy, Kirkland (CA); Debashish Purkayastha, Collegeville, PA (US)

(73) Assignee: INTERDIGITAL PATENT HOLDINGS, INC., Wilmington, DE (US)

(21) Appl. No.: 12/969,136

(22) Filed: Dec. 15, 2010

Related U.S. Application Data
(60) Provisional application No. 61/286,722, filed on Dec. 15, 2009.
(60) Provisional application No. 61/286,723, filed on Dec. 15, 2009.
(60) Provisional application No. 61/295,491, filed on Jan. 15, 2010.
(60) Provisional application No. 61/295,313, filed on Jan. 15, 2010.
(60) Provisional application No. 61/295,494, filed on Jan. 15, 2010.

(51) Int. Cl. G06F 15/16

(52) U.S. Cl. 709/227

(57) ABSTRACT

A method and apparatus for performing session release are provided. For a transferred communication session between a plurality of wireless transmit/receive units (WTRUs) and a remote device, wherein at least one of the WTRUs performs the transferred communication session in association with a first Internet Protocol Multimedia Subsystem (IMS) and at least one other of the WTRUs performs the transferred communication session in association with a second IMS, session release may include releasing the transferred communication session, a portion thereof, one or more of the WTRUs, or a collaborative session associated with the transferred communication session while maintaining service continuity. Any one of the plurality of WTRUs or the remote device may initiate the session release by transmitting a release request. Any one of the plurality of WTRUs may control the transferred communication session and may modify or reject a release request.

### CROSS REFERENCE TO RELATED APPLICATIONS

This application claims the benefit of U.S. Provisional Application No. 61/286,722 filed Dec. 15, 2009, U.S. Provisional Application No. 61/286,723 filed Dec. 15, 2009, U.S. Provisional Application No. 61/295,491 filed Jan. 15, 2010, U.S. Provisional Application No. 61/295,313 filed Jan. 15, 2010, and U.S. Provisional Application No. 61/295,494 filed Jan. 15, 2010, the contents of which are hereby incorporated by reference herein.

### BACKGROUND

A wireless transmit/receive unit (WTRU) may participate in a communication session with a remote unit via an access network, such as a radio access network, for example, a Universal Mobile Telecommunication System (UMTS) Terrestrial Radio Access Network (UTRAN), a Long Term Evolution (LTE) network, a Worldwide Interoperability for Microwave Access (WiMax) network, or a Wireless Local Area Network (WLAN) network. Accordingly, it would be advantageous for a WTRU to duplicate a communication session on a second WTRU.

### SUMMARY

A method and apparatus for performing session release are provided. For a transferred communication session between a plurality of wireless transmit/receive units (WTRUs) and a remote device, wherein at least one of the WTRUs performs the transferred communication session in association with a first Internet Protocol Multimedia Subsystem (IMS) and at least one other of the WTRUs performs the transferred communication session in association with a second IMS, session release may include releasing the transferred communication session, a portion thereof, one or more of the WTRUs, or a collaborative session associated with the transferred communication session while maintaining service continuity. Any one of the plurality of WTRUs or the remote device may initiate the session release by transmitting a release request. Any one of the plurality of WTRUs may control the transferred communication session and may modify or reject a release request.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows a diagram of an example of an Internet Protocol Multimedia Subsystem;

FIG. 3 shows a diagram of an example of a communication session between a first WTRU and a remote device;

FIG. 4 shows a diagram of an example of a transferred communication session including a first WTRU and a second WTRU;

FIG. 5 shows a diagram of an example of a transferred communication session including a first WTRU, a second WTRU, and a third WTRU;

FIG. 6 shows a diagram of an example of session release initiated by a first WTRU;

FIG. 7 shows a diagram of an example of session release anchored at a second IMS;

FIG. 8 shows a diagram of an example of session release initiated by a second WTRU;

FIG. 9 shows a diagram of an example of session release of a second WTRU;

FIG. 10 shows a diagram of an example of session release initiated by a remote device;

FIG. 11 shows a diagram of an example of session release initiated by the a WTRU; and

FIG. 12 shows a diagram of an example of session release including a request to transfer a portion of a communication session.

### DETAILED DESCRIPTION

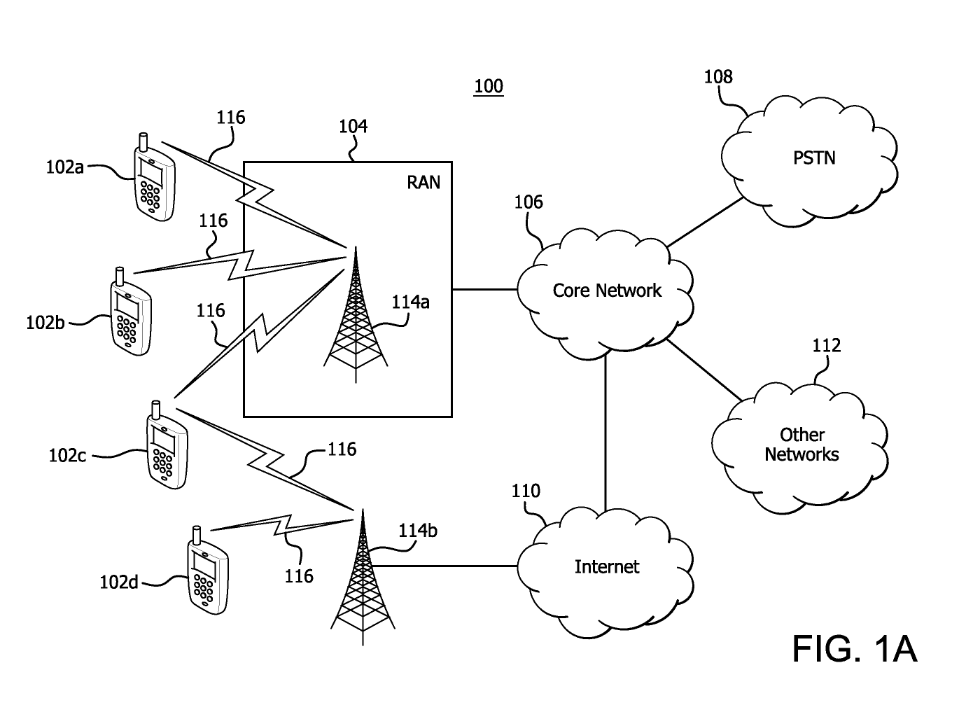

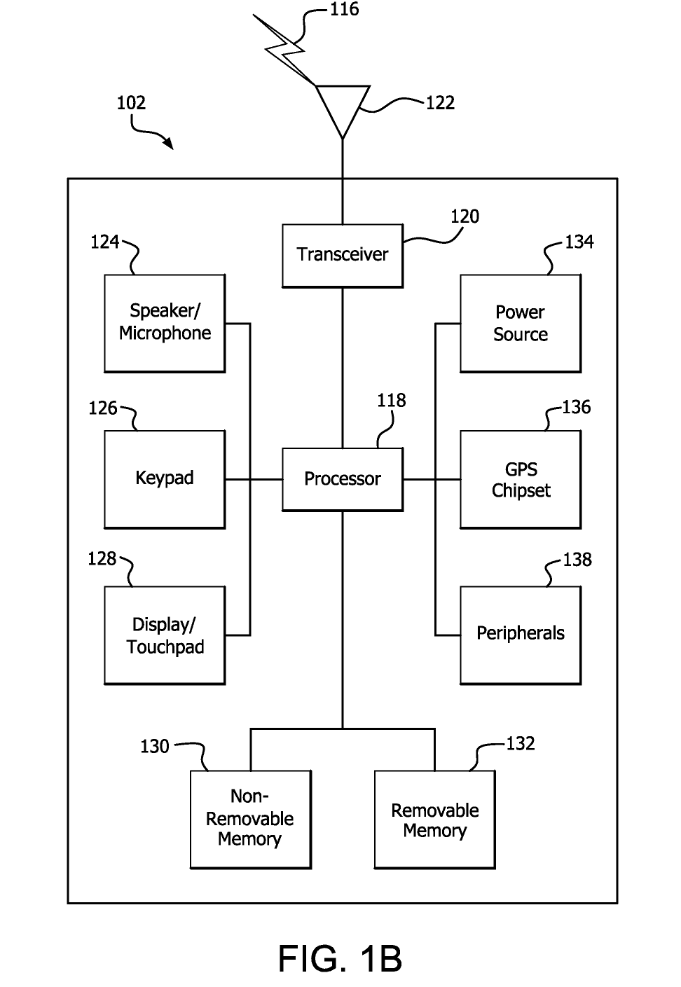

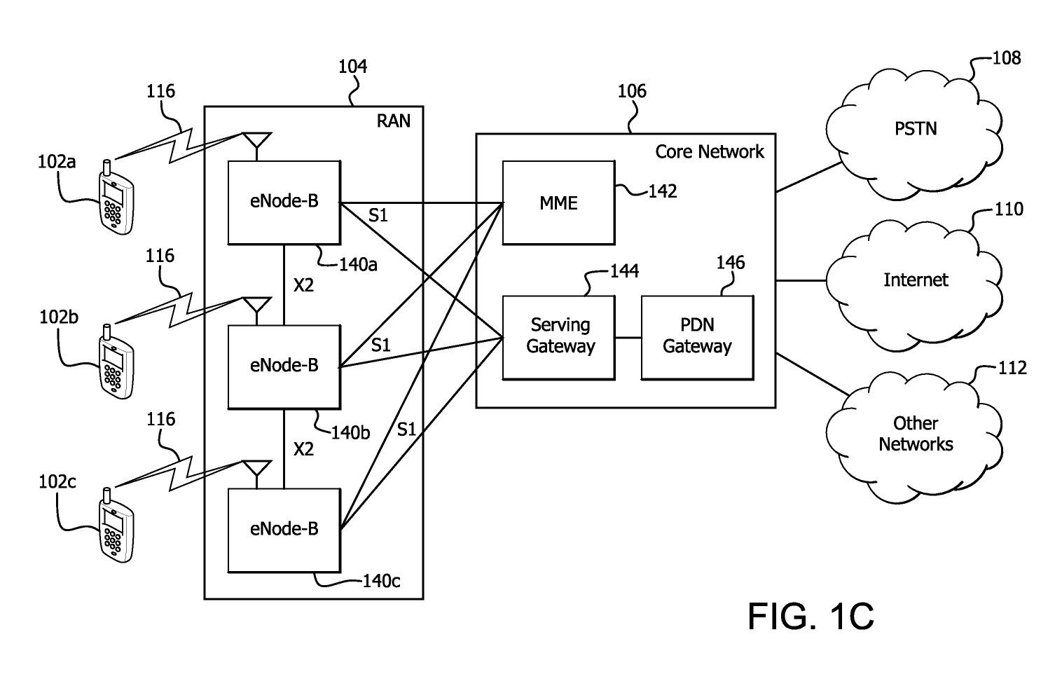

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Wireless, or wired, communication may include using an IP Multimedia (IM) Subsystem (IMS). For example, in LTE, as shown in FIG. 1C, or any other RAN/Core network, the Other Networks 112 may include IMS. A communication session using IMS may be transferred, or duplicated, from one WTRU to another.

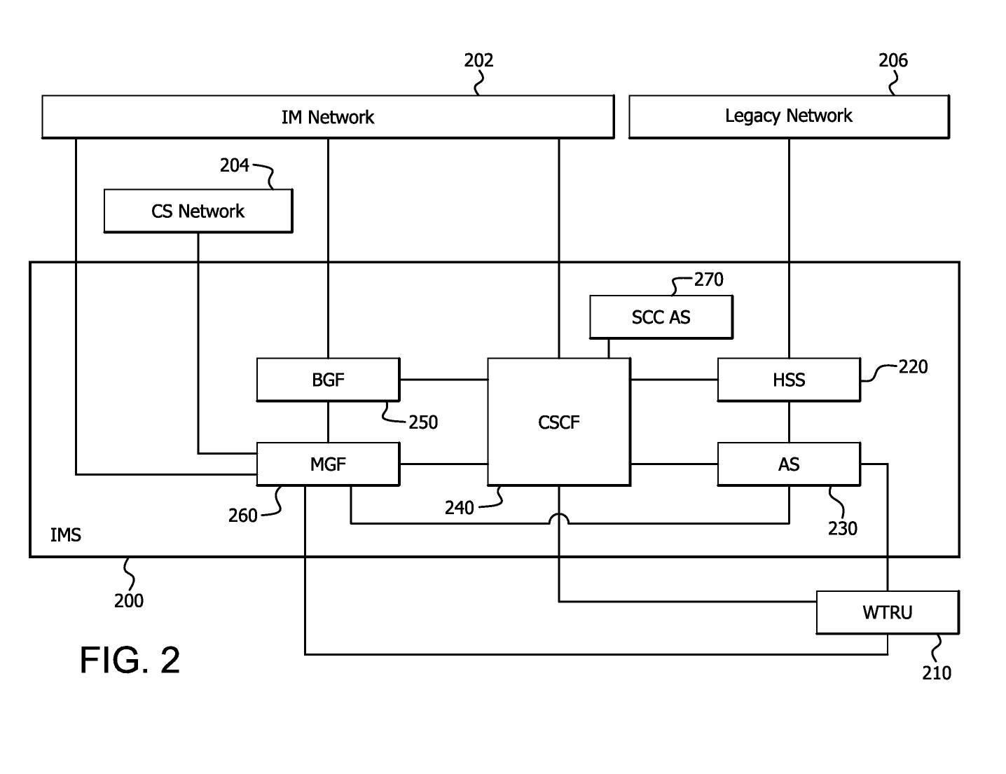

FIG. 2 is a diagram of an example of a Internet Protocol (IP) IP multimedia core network (IM CN), including an IP Multimedia (IM) Subsystem (IMS) 200, an IM network 202, a Circuit Switched (CS) network 204, a legacy network 206, in communication with a wireless transmit/receive unit (WTRU) 210, such as the WTRU shown in FIG. 1B. The IMS 200 includes core network (CN) elements for provision of IM services, such as audio, video, text, chat, or a combination thereof, delivered over the packet switched domain. As shown, the IMS 200 includes a Home Subscriber Server (HSS) 220, an Application Server (AS) 230, a Call Session Control Function (CSCF) 240, a Breakout Gateway Function (BGF) 250, a Media Gateway Function (MGF) 260, and a Service Centralization and Continuity Application Server (SCC AS) 270. In addition to the logical entities and signal paths shown in FIG. 2, an IMS may include any other configuration of logical entities which may be located in one or more physical devices. Although not shown in this logical example, the WTRU may be a separate physical unit and may be connected to the IM CN via a base station such as, a Node-B or an enhanced-NodeB (eNB).

The WTRU 210 may be any type of device configured to operate and/or communicate in a wired and/or wireless environment.

The HSS 220 may maintain and provide subscription-related information to support the network entities handling IM sessions. For example, the HSS may include identification information, security information, location information, and profile information for IMS users.

The AS 230, which may be, for example a SIP Application Server, an OSA Application Server, or a CAMEL IM-SSF, may provide value added IM services and may reside in a home network or in a third party location. The AS may be included in a network, such as a home network, a core network, or a standalone AS network. The AS may provide IM services. For example, the AS may perform the functions of a terminating user agent (UA), a redirect server, an originating UA, a SIP proxy, or a third party call control.

The CSCF 240 may include a Proxy CSCF (P-CSCF), a Serving CSCF (S-CSCF), an Emergency CSCF (E-CSCF), or an Interrogating CSCF (I-CSCF). For example, a P-CSCF may provide a first contact point for the WTRU within the IMS, a S-CSCF may handle session states, and a I-CSCF may provide a contact point within an operator's network for IMS connections destined to a subscriber of that network operator, or to a roaming subscriber currently located within that network operator's service area.

The BGF 250 may include an Interconnection Border Control Function (IBCF), a Breakout Gateway Control Function (BGCF), or a Transition Gateway (TrGW). Although described as a part of the BGF, the IBCF, the BGCF, or the TrGW may each represent a distinct logical entity and may be located in one or more physical entities.

The IBCF may provide application specific functions at the SIP/SDP protocol layer to perform interconnection between operator domains. For example, the IBCF may enable communication between SIP applications, network topology hiding, controlling transport plane functions, screening of SIP signaling information, selecting the appropriate signaling interconnect, and generation of charging data records.

The BGCF may determine routing of IMS messages, such as SIP messages. This determination may be based on information received in the signaling protocol, administrative information, or database access. For example, for PSTN/CS Domain terminations, the BGCF may determine the network in which PSTN/CS Domain breakout is to occur and may select a MGCF.

The TrGW may be located on the media path, may be controlled by an IBCF, and may provide network address and port translation, and protocol translation.

The MGF 260 may include a Media Gateway Control Function (MGCF), a Multimedia Resource Function Controller (MRFC), a Multimedia Resource Function Processor (MRFP), an IP Multimedia Subsystem—Media Gateway Function (IMS-MGW), or a Media Resource Broker (MRB). Although described as a part of the MGF, the MGCF, the MRFC, the MRFP, the IMS MGW, or the MRB may each represent a distinct logical entity and may be located in one or more physical entities.

The MGCF may control call state connection control for media channels in IMS; may communicate with CSCF, BGCF, and circuit switched network entities; may determine routing for incoming calls from legacy networks; may perform protocol conversion between ISUP/TCAP and the IM subsystem call control protocols; and may forward out of band information received in MGCF to CSCF/IMS-MGW.

The MRFC and MRFP may control media stream resources. The MRFC and MRFP may mix incoming media streams; may source media streams, for example for multimedia announcements; may process media streams, such as by performing audio transcoding, or media analysis; and may provide floor control, such as by managing access rights to shared resources, for example, in a conferencing environment.

The IMS-MGW may terminate bearer channels from a switched circuit network and media streams from a packet network, such as RTP streams in an IP network. The IMS-MGW may support media conversion, bearer control and payload processing, such as, codec, echo canceller, or conference bridge. The IMS-MGW may interact with the MGCF for resource control; manage resources, such an echo canceller; may include a codec. The IMS-MGW may include resources for supporting UMTS/GSM transport media.

The MRB may support the sharing of a pool of heterogeneous MRF resources by multiple heterogeneous applications. The MRB may assign, or releases, specific MRF resources to a call as requested by a consuming application, based on, for example, a specified MRF attribute. For example, when assigning MRF resources to an application, the MRB may evaluate the specific characteristics of the media resources required for the call or calls; the identity of the application; rules for allocating MRF resources across different applications; per-application or per-subscriber SLA or QoS criteria; or capacity models of particular MRF resources.

The SCC AS 270 may provide communication session service continuity, such as duplication, transfer, establishment, or release of communication sessions, among multiple WTRUs, for example, in a subscription. The SCC AS may perform access transfer, session transfer or duplication, Terminating Access Domain Selection (T-ADS), and handling of multiple media flows. The SCC AS may combine or split media flows over one or more Access Networks. For example, a media flow may be split or combined for session transfer or duplication, session release, upon request by the WTRU to add media flows over an additional Access Network during the setup of a session, or upon request by the WTRU to add or release media flows over one or more Access Networks to an existing sessions.

A communication session may be performed using a communication system, such as the communication system shown in FIG. 1A, between a WTRU, such as the WTRU shown in FIG. 1B, and a remote device. The WTRU may access the communication system via a RAN, such as the RAN shown in FIG. 1C, or any other wired or wireless access network. The communication session may include services, such as IP multimedia (IM) services provided by an IM CN, such as the IM CN shown in FIG. 2. For example, the IMS in the IM CN may anchor, or host, the communication session and may provide services, such as session transfer, to support inter-device mobility while maintaining service continuity.

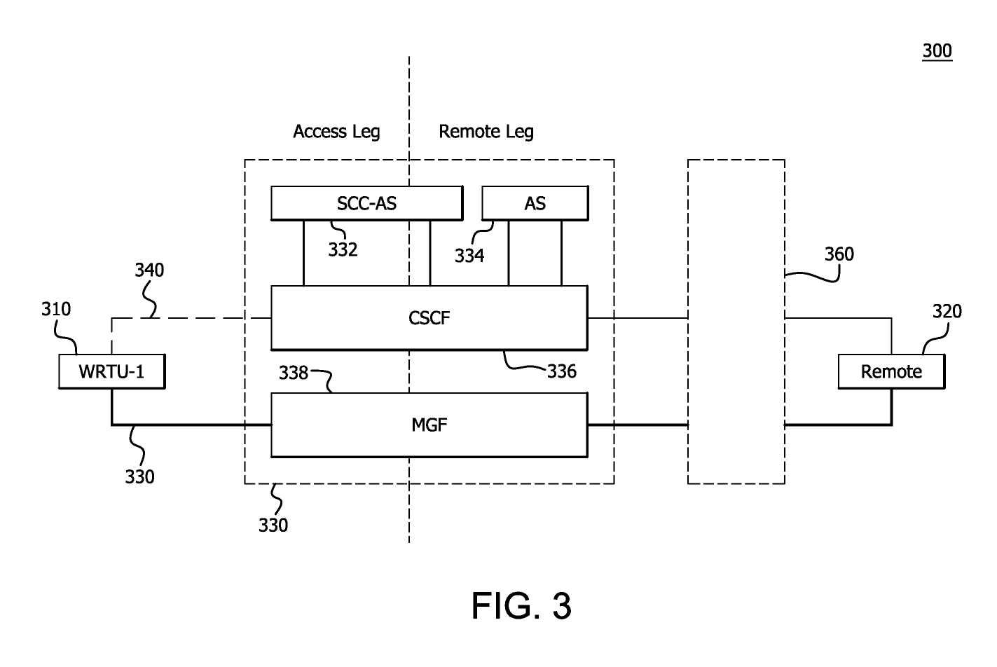

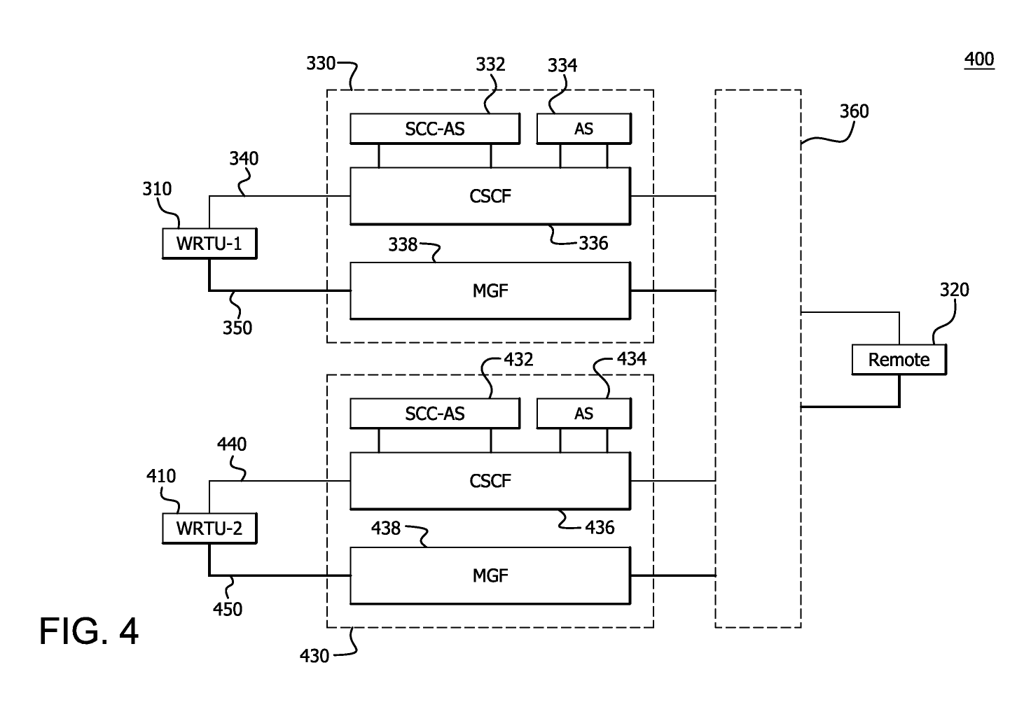

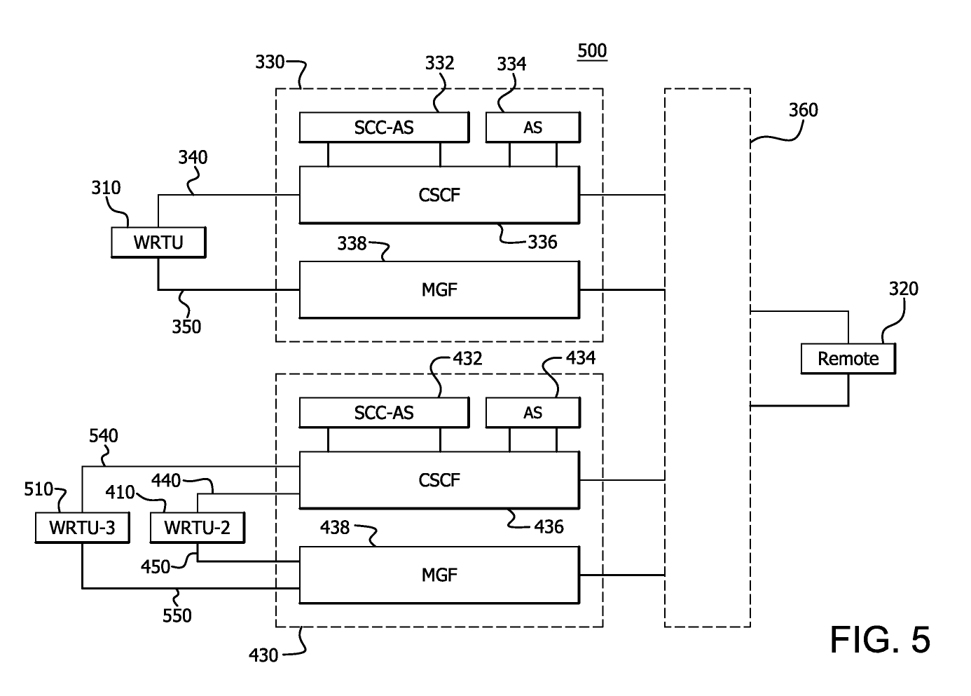

FIGS. 3-5 show examples of a communication session between one or more WTRUs and a remote device. The communication session may include a first WTRU communicating via a first IMS, which may be associated with a first operator, as shown in FIG. 3. The first WTRU may transfer a portion of the communication session to a second WTRU. As shown in FIG. 4, the second WTRU may be included in the communication session via a second IMS, which may be associated with a second operator. The second WTRU may transfer a portion of the communication session to a third WTRU, which may be included in the communication session via the second IMS, as shown in FIG. 5.

FIG. 3 is a diagram of an example of a communication session 300 between a first WTRU 310 (WTRU-1) and a remote device 320. The first WTRU 310 may participate in the communication session via a first IMS 330. The first IMS 330 may include a first SCC AS 332, a first AS 334, a first CSCF 336, and a first MGF 338. The communication session 300 may include signaling paths between the first WTRU 310 and the remote device 320, such as a first control path 340 for control signaling and a first media path 350 for media flow signaling. The remote device 320 may participate in the communication session 300 via a remote network 360, such as the Internet, in communication with the first IMS 330.

FIG. 4 shows a diagram of an example of a transferred communication session 400. The transferred communication session 400 is similar to the communication session 300 shown in FIG. 3, except that the signaling paths are split to transfer a portion of the communication session from the first WTRU 310 to a second WTRU 410.

The second WTRU (WTRU-2) 410 may participate in the transferred communication session 400 via a second IMS 430 which may include a second SCC AS 432, a second AS 434, a second CSCF 436, and a second MGF 438. The portion of the transferred communication session 400 associated with the second WTRU 410 may include a second control path 440 and a second media path 450. Although not explicitly shown, the first IMS 330 and the second IMS 430 may communicate with each other, for example via the Internet. The first WTRU 310 and the second WTRU 410 may be associated via a collaborative session.

FIG. 5 shows a diagram of an example of a transferred communication session 500. The transferred communication session 500 is similar to the transferred communication session 400 shown in FIG. 4, except that the signaling paths associated with the second WTRU 410 are split to transfer a portion of the communication session from the second WTRU 410 to a third WTRU (WTRU-3) 510.

The third WTRU 510 may participate in the transferred communication session 500 via the second IMS 430. The portion of the transferred communication session 500 associated with the third WTRU 510 may include a third control path 540 and a third media path 550. The first WTRU 410, the second WTRU 410, and the third WTRU 510 may be associated via a collaborative session. Although not shown, the second WTRU 410 and the third WTRU 510 may be associated via a second collaborative session.

Although FIG. 4 shows a second WTRU 410 participating in the communication session via a second IMS 430, and FIG. 5 shows a third WTRU 510 participating in the communication session via the second IMS 430, a communication session may be transferred to any number of WTRUs participating via any number of IMSs. The WTRUs may be separate physical devices, may be separate physical interfaces in a single physical device, or may be a combination thereof.

The transferred communication session 400/500 may be anchored, or hosted, at one or more of the associated IMSs 330/340. For example, a SCC AS in the anchor IMS may maintain information regarding the communication session, such as media flow identifiers and controlling device identifiers, and may provide call control, such as session transfer, for the communication session. The anchor IMS may be a back-to-back user agent (B2BUA) and may receive and forward, modified or unmodified, control signals for a communication session. An IMS that is not an anchor IMS may be a proxy IMS and may receive and forward control signals for a communication session.

To release the transferred communication session 400/500, or a portion thereof, while maintaining service continuity, the participating WTRUs 310/410/510 or the remote device 320 may initiate session release. Session release may be initiated based on metrics, such as signal quality information, policies, or in response to input from a user or subscriber.

Session release may include releasing, or redirecting, the transferred communication session 400/500, or a portion thereof, such as a media flow, a WTRU, or a collaborative session, while maintaining service continuity. The portion of the communication session targeted for release may be associated with the entity initiating the session release, or with any other WTRU 310/410/510 participating in the transferred communication session 400/500. Although described with reference to IMS herein, session release may be performed using any communication system, access network, or IM CN.

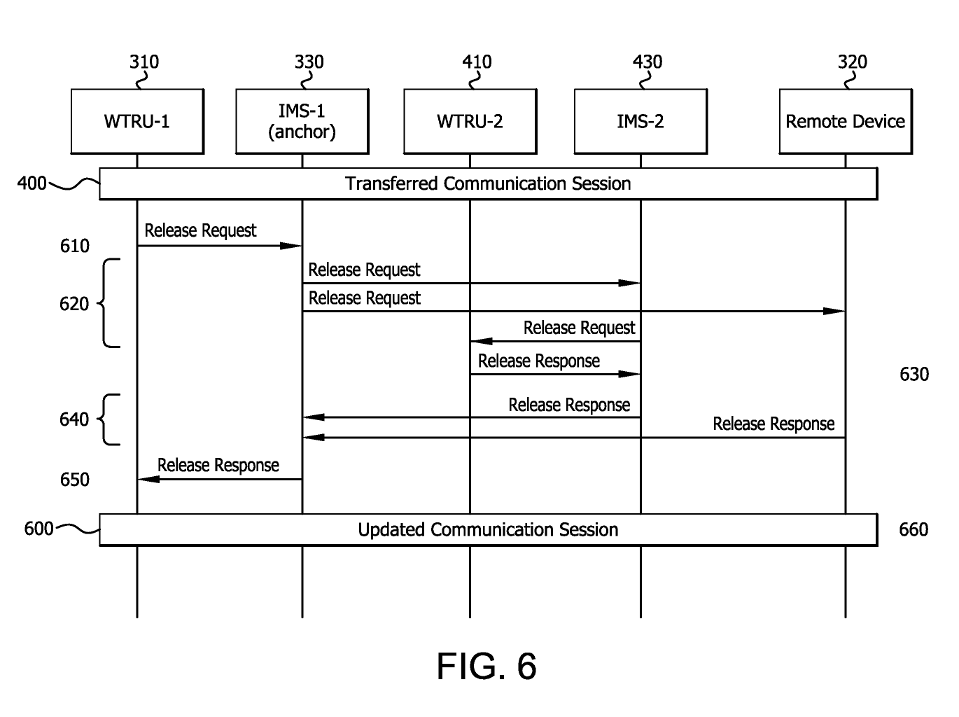

FIGS. 6-12 show examples of session release for the transferred communication session 400/500. The elements shown in FIGS. 6-12 may be used alone or in combination with any other element described herein.

FIG. 6 is a diagram of an example of session release. The transferred communication session 400, as shown in FIG. 4, is anchored at the first IMS 330, session release is initiated by the first WTRU 310, and a portion of the transferred communication session that is associated with the second WTRU 410 is targeted for release.

The first WTRU 310 may initiate session release by sending a release request, such as a SIP re-Invite, or UPDATE, message, to the first IMS 330 at 610. The release request may include an identifier associated with the portion of the communication session targeted for release, such as a media flow identifier, and may indicate a request to release of the targeted portion of the communication session. For example, the release request may indicate a request to direct a targeted media flow to port 0.

The first IMS 330 may anchor the communication session and may receive and process the release request. For example, the SCC AS 332 in the first IMS 330 may determine that the portion of the transferred communication session that is targeted for release is associated with the second WTRU 410, and may determine that the second WTRU 410 is associated with the second IMS 430. The first IMS 330 may send the release request to the second WTRU 410 via the second IMS 430 and to the remote device 320 at 620. Although not shown, the anchor IMS 330 may send the release request to the second WTRU 410 in response to a release response from the remote device.

The second WTRU 410 may send the response message to the second IMS 430 at 630.

The second IMS 430 and the remote device 320 may each send a release response, such as an acknowledgment (ACK) message, to the anchor IMS 330 at 640.

The anchor IMS 330 may send the response message to the first WTRU 310 at 650.

The targeted portion of the communication session may be released and the first WTRU 310 and the second WTRU 410 may continue the updated communication session 600 with the remote device 320 at 660.

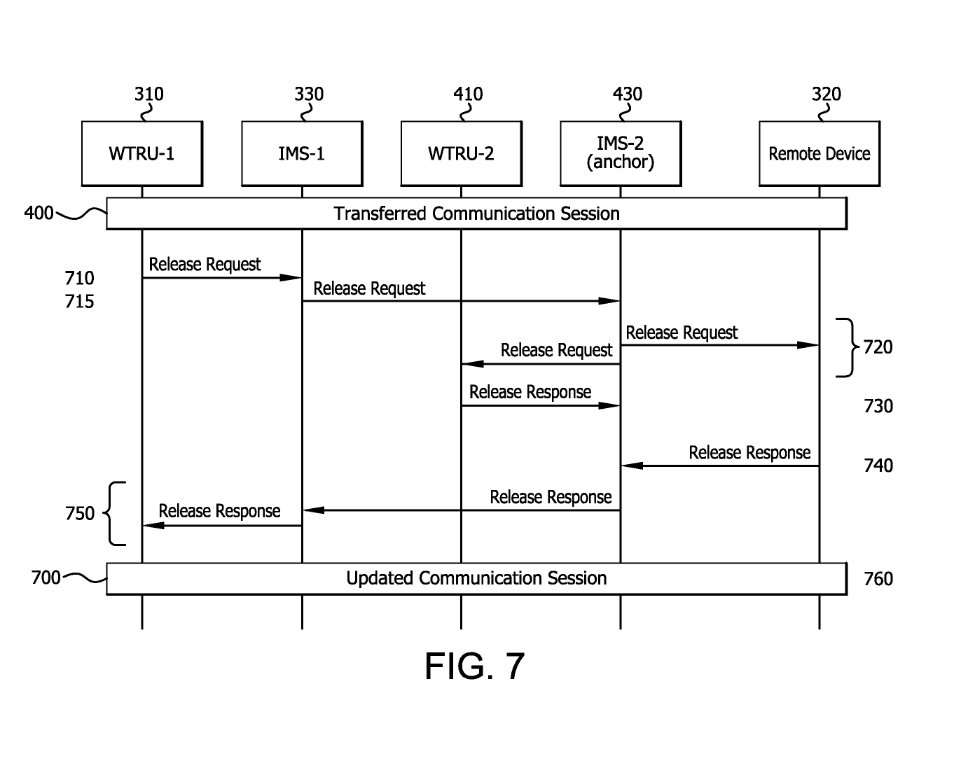

FIG. 7 is a diagram of another example of session release. The example shown in FIG. 7 is similar to the example shown in FIG. 6 except that the transferred communication session 400, as shown in FIG. 4, is anchored at the second IMS 430 and the session release includes transferring a portion of the transferred communication session 400.

The first WTRU 310 may initiate session release by sending a release request to the first IMS 430 at 710. The release request may indicate a request to transfer the targeted portion of the communication session. For example, the release request may include a request to transfer the targeted portion of the communication session to the first WTRU 310.

The first IMS 330 may send the release request to the anchor IMS 430 at 715.

The anchor IMS 430 may receive and process the release request. For example, the SCC AS 432 in the second IMS 430 may determine that the portion of the transferred communication session that is targeted for release is associated with the second WTRU 410. The second IMS 330 may send the release request to the second WTRU 410 and to the remote device 320 at 720.

The second WTRU 410 may send a release response, such as an acknowledgment (ACK) message, to the anchor IMS 430 at 730.

The remote device 320 may send a release response, such as an acknowledgment (ACK) message, to the anchor IMS 430 at 740.

The anchor IMS 430 may send the response message to the first WTRU 310 via the first IMS 330 at 750.

The targeted portion of the transferred communication session may be transferred to the first WTRU 310, and the first WTRU 310 and the second WTRU 410 may continue the updated communication session 700 with the remote device 320 at 760.

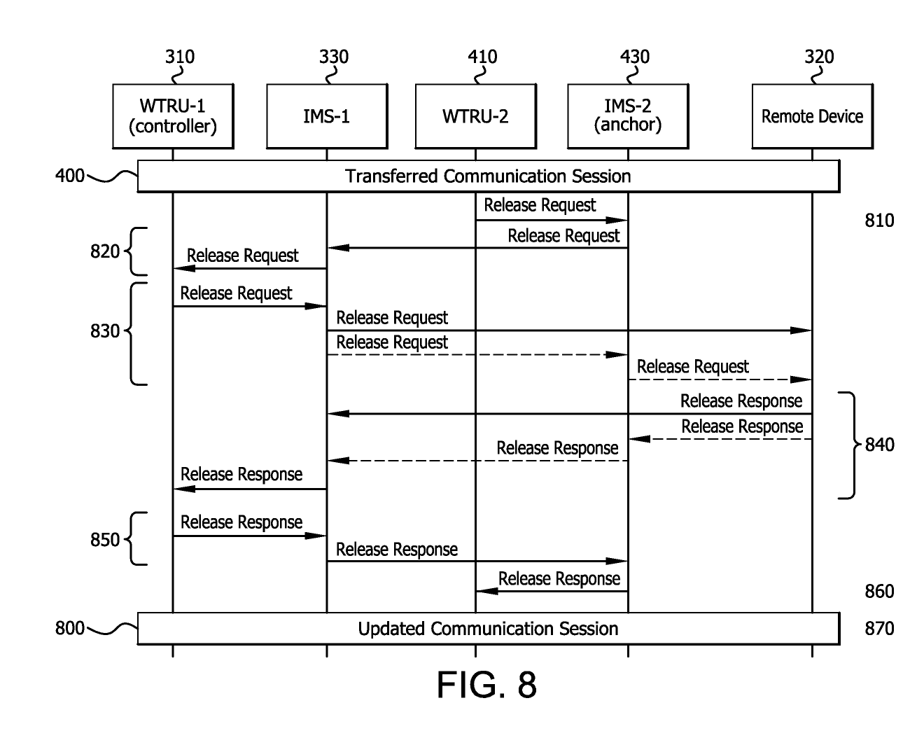

FIG. 8 is a diagram of another example of session release with reference to the transferred communication session 400, as shown in FIG. 4. The example of session release for shown in FIG. 8 is similar to the example shown in FIGS. 6 and 7, except that the session release is initiated by the second WTRU 410, the first WTRU 330 is a controller WTRU, and the portion of the transferred communication session targeted for release is associated with the first WTRU 310.

Control signaling for a communication session may be sent via the anchor IMS or may be sent via the IMS associated with the WTRU sending the control signal. Session release may include direct signaling, indirect signaling, or a combination thereof. Direct signaling may include signaling from an IMS sending a message, such as a release request, directly to an intended recipient. Indirect signaling may include an IMS sending a message indirectly, via another IMS. In FIG. 8, indirect signaling is indicated using broken lines.

The second WTRU 410 may initiate session release by sending a release request to the second IMS 430 at 810. The release request may indicate a request to release a portion of the communication session associated with the first WTRU 310.

The second IMS 430 may anchor the communication session, and may receive and process the release request. For example, the SCC AS 432 in the second IMS 430 may determine that the portion of the transferred communication session that is targeted for release is associated with the first WTRU 310, and may determine that the first WTRU 310 is associated with the first IMS 330. The anchor IMS 430 may send the release request to the first WTRU 310 via the first IMS 330 at 820.

The first WTRU 310 may send the release request to the remote device 320 via the first IMS 330 at 830. The first IMS 330 may send the release request directly to the remote device 320 or may send the release request indirectly via the anchor IMS 430. Although not shown, the first WTRU 310 may control the transferred communication session 400 and may reject the release request.

The remote device 320 may send a release response, such as an acknowledgment (ACK) message, to the first IMS 330 at 840. The remote device 320 may send the release request directly to the first IMS 330, or indirectly via the anchor IMS 430.

The first IMS 330 may send the response message to the first WTRU 310 and the anchor IMS 430 at 850.

The anchor IMS 430 may send the response message to the second WTRU 410 at 860.

The targeted portion of the communication session may be released and the first WTRU 310 and the second WTRU 410 may continue the updated communication session 800 with the remote device 320 at 870.

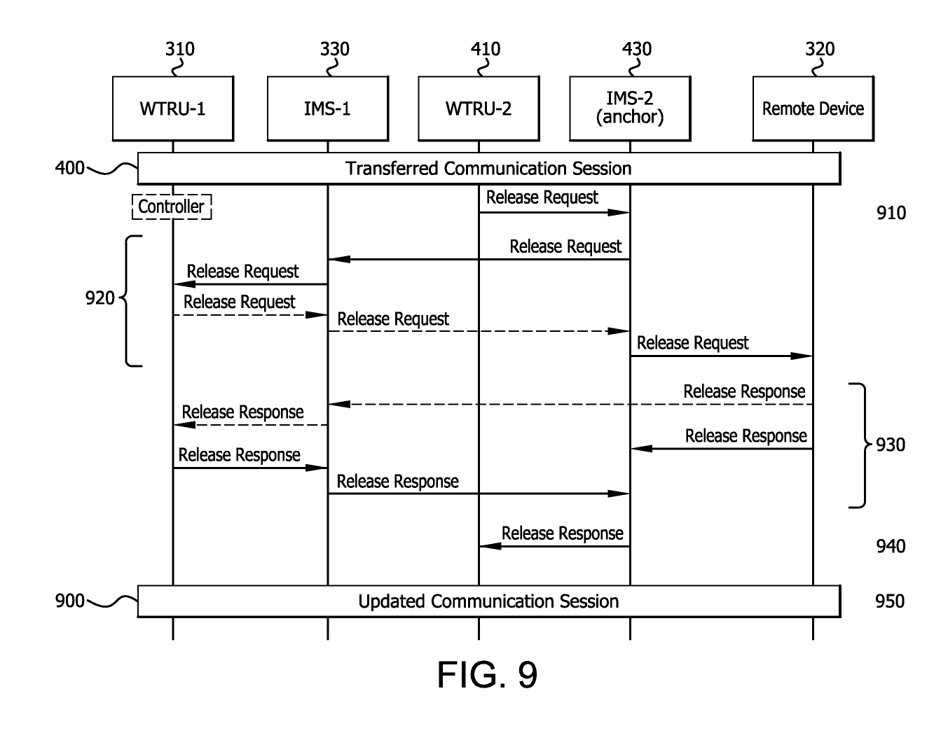

FIG. 9 is a diagram of another example of session release, with reference to the transferred communication session 400, as shown in FIG. 4. The example shown in FIG. 9 is similar to the example shown if FIGS. 6-8, except that the second WTRU 410 is targeted for release.

Session release may include session control, such as in a collaborative session, wherein a controller WTRU, which may include one or more of the WTRUs associated with the transferred communication session 400, may reject or modify a release request. In FIG. 9, session control is indicated using broken lines.

The second WTRU 410 may initiate session release by sending a release request to the second IMS 430 at 910. The release request may indicate a request to release the second WTRU 410 from the communication session. For example, the release request may include a SIP BYE message indicating a request to release the second WTRU 410 from the communication session. In another example, the release request may include a SIP re-INVITE message, indicating a request to release the portions of the transferred communication session associated with the second WTRU 410.

The second IMS 430 may anchor the transferred communication session 400, and may receive and process the release request. The anchor IMS 430 may send the release request to the first WTRU 310 via the first IMS 330 and to the remote device 320 at 920. As shown using broken lines, the first WTRU 310 may be a controller WTRU and the anchor IMS 430 may send the release request to the remote device 320 in response to a message from the controller WTRU 310. For example, the controller WTRU 310 may modify the release request to indicate a request to transfer the portion of the communication session associated with the second WTRU 410, and the anchor IMS 430 may send the modified release request to the remote device 320.

The first WTRU 310 may send a release response to the first IMS 330, and the first IMS 330 and the remote device 320 may each send a release response to the anchor IMS 430 at 930. As shown using broken lines, the first WTRU 310 may be a controller WTRU and the remote device 320 may send the release response to the first WTRU 310 via the first IMS 330.

The anchor IMS 430 may send the response message to the second WTRU 410 at 940.

The portion of the communication session associated with the second WTRU 410 may be released, or transferred, and the first WTRU 310 may continue the updated communication session 900 with the remote device 320 at 950. The second WTRU 410 and the second IMS 430 may cease performing the updated communication session 900. The first IMS 330 may anchor the updated communication session 900.

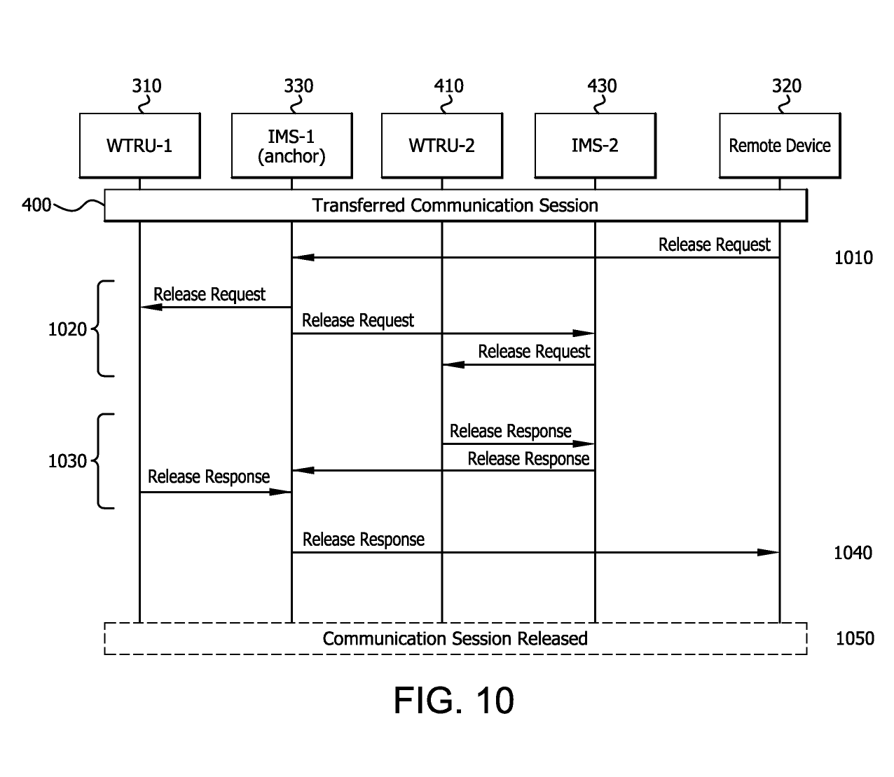

FIG. 10 is a diagram of another example of session release, with reference to the transferred communication session 400, as shown in FIG. 4. The example shown in FIG. 10 is similar to the examples shown in FIGS. 6-9, except that the session release is initiated by the remote device 320 and the communication session is targeted for release.

The remote device 320 may initiate session release by sending a release request, such as a SIP BYE message, to the anchor IMS 330 at 1010. The release request may indicate a request to release the communication session.

The first IMS 330 may anchor the communication session, and may receive and process the release request. For example, the SCC AS 332 in the first IMS 330 may determine that a portion of the transferred communication session is associated with the first WTRU 310, that a portion of the transferred communication session is associated with the second WTRU 410, and may determine that the second WTRU 410 is associated with the second IMS 430. The anchor IMS 330 may send the release request to the first WTRU 310 and to the second WTRU 410 via the second IMS 430 at 1020.

The second WTRU 410 may send a release response to the second IMS 430, and the first WTRU 310 and the second IMS 430 may each send a release response to the anchor IMS 330 at 1030.

The anchor IMS 330 may send the response message to the remote device 320 at 1040.

The first WTRU 310, the second WTRU 410, and remote device 320 may release the communication session at 1050.

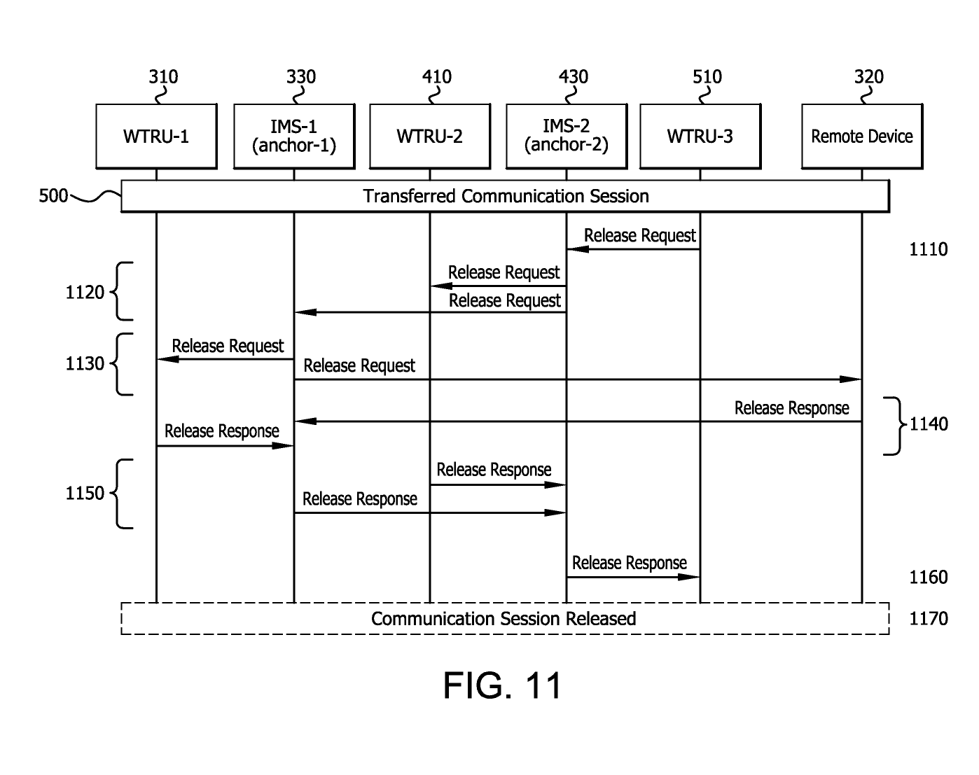

FIG. 11 is a diagram of another example of session release. The example shown in FIG. 11 is similar to the examples shown in FIGS. 6-10, except that the session release includes a release of a portion of the transferred communication session 500 shown in FIG. 5, and the session release is initiated by the third WTRU 510. The first IMS 330 may anchor a first portion of the transferred communication session 500, such as the portion not associated with the third WTRU 510, and the second IMS 430 may anchor a second portion of the transferred communication session 500, such as the portion associated with the third WTRU 510.

The third WTRU 510 may initiate session release by sending a release request to the second IMS 430 at 1110. The release request may indicate a request to release the communication session.

The second IMS 430 may receive and process the release request. For example, the SCC AS 432 in the second IMS 430 may determine that a portion of the transferred communication session is associated with the second WTRU 410, that a portion of the transferred communication session is associated with the first WTRU 310, and that a portion of the communication session is anchored at the first IMS 330. The second IMS 430 may send the release request to the second WTRU 410 and to the first IMS 330 at 1120.

The first IMS 330 may receive and process the release request. The first IMS 330 may send the release request to the first WTRU 310 and to the remote device 320 at 1130.

The first WTRU 310 and the remote device 320 may each send a release response to the first IMS 330 at 1140.

The first IMS 330 and the second WTRU 410 may each send a release response to the second IMS 430 at 1150.

The second IMS 430 may send the response message to the third WTRU 510 at 1160.

The first WTRU 310, the second WTRU 410, the third WTRU 510, and remote device 320 may release the communication session at 1170.

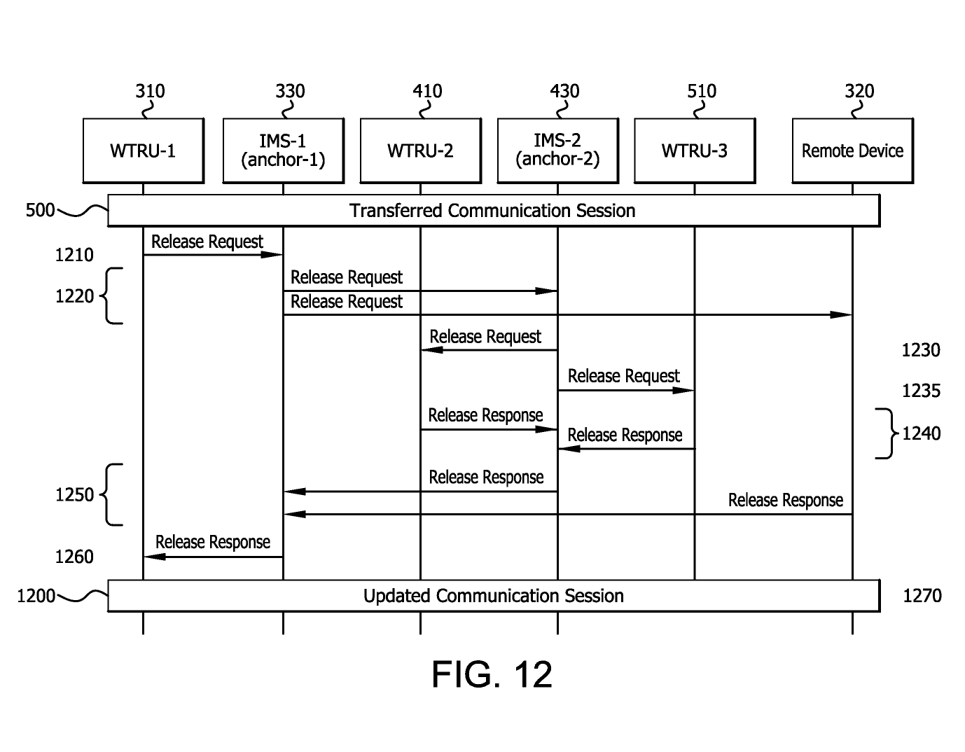

FIG. 12 is a diagram of another example of session release, with reference to the transferred communication session 500, as shown in FIG. 5. The example shown in FIG. 12 is similar to the examples shown in FIGS. 6-11, except that the session release includes a request to transfer a portion of the transferred communication session 500 that is associated with the third WTRU 510.

The first WTRU 310 may initiate session release by sending a release request to the first IMS 330 at 1210. The release request may indicate a request to transfer a portion of the transferred communication session 500.

Although not shown, the release request may include a request to release a collaborative session. For example, the release request may include a SIP BYE message indicating each of the WTRUs associated with the collaborative session; a plurality of BYE messages, each indicating a WTRU associated with the collaborative session; a SIP re-INVITE message indicating each portion of the communication session associated with the collaborative session, or a plurality of re-INVITE messages, each indicating a portion of the communication session associated with the collaborative session.

The first IMS 330 may receive and process the release request. For example, the SCC AS 332 in the first IMS 330 may determine that the targeted portion of the transferred communication session 500 is associated with the second WTRU 410, and that the second WTRU 410 is associated with the second IMS 430. The first IMS 330 may send the release request to the second IMS 430 and to the remote device 320 at 1220.

The second IMS 430 may receive and process the release request. For example, the SCC AS 432 in the second IMS 430 may determine that the targeted portion of the transferred communication session 500 is the only portion of the transferred communication session 500 that is associated with the third WTRU 510. The second IMS 430 may send a release request, such as a SIP re-INVITE, to the second WTRU 410 at 1230. The second IMS 430 may send a release request, such as a SIP BYE message, to the third WTRU 510 at 1235.

The second WTRU 410 and the third WTRU 510 may each send a release response to the second IMS 430 at 1240.

The second IMS 430 and the remote device 320 may each a release response to the first IMS 330 at 1250.

The first IMS 330 may send the release response to the first WTRU 310 at 1260.

The portion of the communication session associated with the third WTRU 510 may be transferred, and the first WTRU 310 and the second WTRU 410 may continue the updated communication session 1200 with the remote device 320 at 1270. The third WTRU 510 may cease performing the updated communication session 1200. The first IMS 330 may anchor the updated communication session 1200.

The examples shown in FIGS. 4-12 include variations in the number of entities participating in a communication session, the relationships among the entities, and the session release signaling; however, the examples shown are not exhaustive, and the examples shown, or any elements thereof, may be used alone or in any combination. For example, and by no way limiting, some of the elements shown in FIGS. 6-12 are indicated in Table 1, and Table 2 indicates a non-exhaustive list of other combinations of elements which, for simplicity, are not separately shown herein.

TABLE 1

| | | FIG. | | | | | | |
|---|---|---|---|---|---|---|---|---|
| | | 6 | 7 | 8 | 9 | 10 | 11 | 12 |
| Transfer | WTRU-1 | X | X | | | | | X |
| Initiated | WTRU-2 | | | X | X | | | |
| By | WTRU-3 | | | | | | X | |
| | Remote | | | | | X | | |
| Session | IMS-1 | X | | | | X | 4 | 4 |
| Anchor | IMS-2 | | X | X | X | | 5 | 5 |
| Target for | Media on Self | | | | | | | |
| release | Media on | X | X | X | | | | 4 |
| | Other | | | | | | | |
| | WTRU (self) | | | | X | | | |
| | WTRU-Other | | | | | | | 5 |
| | Session | | | | | X | X | |
| | Collaborative | | | | | | | |
| Signaling | Direct | X | X | X | X | X | X | X |
| | Indirect | | | # | # | | | |
| | Anchor | X | X | # | X | X | 4 | 4 |
| | Controller | X | X | X | # | X | X | |
| | Target | | X | X | # | N/A | N/A | |
| Control Signaling | | | | X | X | N/A | X | |
| Controller | WTRU-1 | X | | X | X | X | 4 | 4 |
| | WTRU-2 | | X | | | | 5 | 5 |

# shown as broken line
4 - first transfer;
5 - second transfer

TABLE 2

| Transfer | WTRU-1 | | | X | X | | | | X | | | | | |
|---|---|---|---|---|---|---|---|---|---|---|---|---|---|---|
| Initiated | WTRU-2 | X | X | | | | X | X | | | X | | | X |
| By | WTRU-3 | | | | | | | | | | | X | | |
| | Remote | | | | | X | | | | X | | | X | |
| Session | IMS-1 | X | | X | X | X | X | X | X | X | X | X | X | X |
| Anchor | IMS-2 | | X | | | | | X | X | X | X | X | | |
| Target for | Media on Self | X | | | | | | | | | | | | |
| release | Media on | | X | X | | | | | | | | | X | |
| | Other | | | | | | | | | | | | | |
| | WTRU (self) | | | | | | | | | | | | | X |
| | WTRU | | | | | | | | | | | | | |
| | (Other) | | | | | | | | | | | | | |
| | Session | | | | X | X | X | X | X | X | X | X | | X |
| | Collaborative | | | | | | | | | | | | | |
| Signaling | Direct | X | X | X | X | X | X | X | X | X | X | X | X | X |
| | Indirect | | | | | | | | | | | | | |
| | Anchor | X | | | X | | X | | X | X | X | X | X | X |
| | Controller | X | X | | X | X | X | X | X | X | X | X | X | X |
| | Target | | X | X | N/A | N/A | N/A | N/A | N/A | N/A | N/A | N/A | | |
| Control Signaling | | | X | X | X | | X | | | | | | N/A | X |
| Controller | WTRU-1 | X | X | X | X | X | X | X | X | X | X | X | X | X |
| | WTRU-2 | | | | | | | | | | | | | |

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in wireless communication, the method comprising:
performing a session release for a transferred communication session between a plurality of wireless transmit/receive units (WTRUs) and a remote device while maintaining service continuity, wherein the plurality of WTRUs includes a first WTRU performing a first portion of the transferred communication session in association with a first network, and a second WTRU performing a second portion of the transferred communication session in association with a second network, where the second portion of the transferred communication session is a transferred portion of the transferred communication session.

2. The method of claim 1, wherein the performing the first portion of the transferred communication session in association with the first network includes performing the first portion of the transferred communication session in association with a first Internet Protocol multimedia subsystem (IMS) in the first network, and the performing the second portion of the transferred communication session in association with the second network includes performing the second portion of the transferred communication session in association with a second Internet Protocol multimedia subsystem (IMS) in the second network.

3. The method of claim 1, wherein the performing the session release includes releasing the transferred communication session, releasing a portion of the transferred communication session, releasing one or more of the plurality of WTRUs, or releasing a collaborative session associated with the transferred communication session.

4. The method of claim 1, wherein the transferred communication session includes a plurality of media flows, and the performing the session release includes releasing a media flow selected from the plurality of media flows.

5. The method of claim 1, wherein the performing the session release includes initiating the session release.

6. The method of claim 1, wherein the performing the session release includes sending a release request including a session initiation protocol (SIP) BYE message or a SIP re-INVITE message.

7. The method of claim 1, wherein the performing the session release includes sending a release response in response to receiving a session release request.

8. The method of claim 1, wherein the performing the session release includes transferring a portion of the transferred communication session.

9. The method of claim 1, wherein the plurality of WTRUs includes a third WTRU performing a third portion of the transferred communication session in associated with the first IMS or the second IMS.

10. The method of claim 1, wherein the performing the session release includes receiving a first release request indicating a request to release a portion of the transferred communication session and sending a second release request indicating a request to transfer the portion of the transferred communication session.

11. The method of claim 1, wherein the performing the session release includes receiving a release request and sending a release response rejecting the release request.

12. A method for use in wireless communication, the method comprising:
establishing a communication session between a first wireless transmit/receive unit (WTRU) and a remote device, wherein the communication session includes the first WTRU performing the communication session via a first Internet Protocol multimedia subsystem (IMS);
establishing a transferred communication session by transferring a first portion of the communication session from the first WTRU to a second WTRU while maintaining service continuity, wherein the transferred communication session includes the second WTRU performing the transferred communication session in association with a second IMS; and
performing a session release for the transferred communication session while maintaining service continuity.

13. A wireless transmit/receive unit (WTRU) comprising:
a processor configured to:
establish a communication session with a remote device via a first Internet Protocol multimedia subsystem (IMS),
establish a transferred communication session by transferring a portion of the communication session to a second WTRU while maintaining service continuity, such that the transferred communication session includes the second WTRU performing the transferred communication session in association with a second IMS, and
initiate a session release for the transferred communication session while maintaining service continuity.

14. An Internet Protocol multimedia subsystem (IMS) node comprising:
a memory configured to store transferred communication session information indicating:
a communication session between a plurality of wireless transmit/receive units (WTRUs) and a remote device,
a first WTRU selected from the plurality of WTRUs, performing a first portion of the transferred communication session in association with a first network, and
a second WTRU selected from the plurality of WTRUs, performing a second portion of the transferred communication session in association with a second network, wherein the second portion of the transferred communication session is a transferred portion of the transferred communication session; and
a processor configured to perform a session release for the transferred communication session while maintaining service continuity.

15. A remote device comprising:
a transceiver configured to perform a transferred communication session with a plurality of wireless transmit/receive units (WTRUs), wherein the plurality of WTRUs includes a first WTRU performing a first portion of the transferred communication session in association with a first network, and a second WTRU performing a second portion of the transferred communication session in association with a second network, where the second portion of the transferred communication session is a transferred portion of the transferred communication session; and
a processor configured to initiate a session release for the transferred communication session while maintaining service continuity.
